(19) United States
(12) Patent Application Publication
(10) Pub. No.: US 2019/0208748 A1
(43) Pub. Date: Jul. 11, 2019

(54) RETRACTABLE LEASH AND COLLAR OR HARNESS ASSEMBLY

(71) Applicant: Ciara Young, Naples, FL (US)

(72) Inventor: Ciara Young, Naples, FL (US)

(21) Appl. No.: 16/357,704

(22) Filed: Mar. 19, 2019

Related U.S. Application Data
(63) Continuation-in-part of application No. 15/188,050, filed on Jun. 21, 2016.

(51) Int. Cl. A01K 27/00

(52) U.S. Cl. CPC A01K 27/004; A01K 27/002; A01K 27/001

(57) ABSTRACT

A retractable leash and collar or harness assembly. The assembly includes a flexible handle with a first hub assembly in the forward end thereof. The first hub assembly contains a spring member and leash element coiled and enclosed within the first hub assembly. A second hub assembly located in the collar or harness assembly wherein the second hub assembly contains a spring member and leash element coiled and enclosed within the second hub assembly. The leash is connected to a collar or harness and the handle and collar or harness include a connector thereon to allow the components to be nested with each other and folded to provide a compact retractable leash and collar/harness assembly which is easily transportable by the user.

### PRIORITY

The present application is a Continuation-in-part application and is co-pending with U.S. Ser. No. 15/188,050 filed on Jun. 21, 2016.

### BACKGROUND OF THE INVENTION

This invention relates, generally, to animal leashes. More particularly, it relates to a self-contained assembly containing a collar or harness with a handle having a built-in retractable animal leash.

### DESCRIPTION OF THE PRIOR ART

Pet collars and harnesses for use with dogs and/or cats having integral leashes are well-known in the art. For example, U.S. Patent App. Pub. No. 2008/0163830 describes a retractable leash and collar assembly. wherein the leash is contained within a housing integrated into the surface of the collar. The housing feeds into an aperture that allows the leash to enter and exit the collar.

U.S. Patent App. Pub. No. 2009/0255486 describes a combination pet collar and leash. The collar assembly communicates with the leash and handle assembly. The collar assembly has a circular housing thereon which contains a retraction mechanism that biases a spool to rotatably receive the leash. The handle can be fastened to the collar and lies in overlying relation to the collar and spool when in a retracted position.

U.S. Patent App. Pub. No. 2010/0251970 describes a retractable leash and collar assembly, wherein the leash is contained within a housing integrated into the surface of the collar. The housing feeds into the aperture on the collar that allows the leash to enter and exit the collar.

U.S. Patent App. Pub. No. 2011/0023794 describes an assembly comprising an adjustable collar and retractable leash. The leash is located within a housing on the collar and is wound about a spring-actuated spool. At the other end, the leash is attached to a handle that aesthetically forms a side of the housing when in a retracted position.

U.S. Patent App. Pub. No. 2011/0174238 describes a collar and retractable leash assembly. The collar has a pouch coupled thereto with a retraction assembly contained therein. A cord is connected to the retraction assembly and is wound within the pouch when the apparatus is in a retracted position. A handle is coupled to the end of the cord opposite from the retraction assembly. In the retracted position, the handle is substantially contained within the pouch as well.

U.S. Patent App. Pub. No. 2006/0288960 describes a pet collar with an integral leash wherein the collar includes a retractable cable located in the collar and the hand strap preferably includes snaps or hook and loop type materials to on the inside and outside of the handle to allow it to be fastened to itself and to the collar.

U.S. Pat. No. 3,477,410 describes a collar and retractable leash wherein the spring loaded spool portion of the retractable leash is clipped to the collar with a snap lock. The handle and leash are then pulled from the spool which is attached to the collar.

U.S. Pat. No. 4,018,189 describes a retractable dog leash wherein a spring actuated casing includes the retractable leash therein and the handle of the leash extends from the casing and may be pulled to the extended position of the leash. The casing is described as being attached to the collar by a split ring or similar member.

U.S. Pat. No. 6,481,382 describes a collar and self-retracting leash assembly. In a retracted position, the leash is disposed within the collar along the collar's longitudinal axis. A pulley is also disposed within the collar to facilitate expansion of the leash.

U.S. Pat. No. 6,581,547 describes a pet collar with integrated retractable leash. One end of the leash is attached to a coiled spring, and the other end is attached to the handle. In a retracted position, the leash has a portion fastened to the surface of the collar, and the handle is coupled to the collar as well.

U.S. Pat. No. 7,461,615 describes a pet harness with retractable leash secured to the harness, so that the retractable leash is readily accessible on the pet's back. The leash is disposed within a housing, within which the leash is wound around a spool. The handle of the leash is disposed outside of the housing in the retracted position.

U.S. Pat. No. 7,610,880 describes a retractable leash assembly mounted to a collar or harness, wherein the leash is wound about a spool in a housing in the retracted position and is extendable from the spool in an extended position. The handle remains along the exterior of the housing when retracted.

U.S. Pat. No. 8,919,293 describes a retractable leash assembly that forms an integral part of the dog collar wherein the leash extends through a portion of the collar and is wound around a spool in the collar. In one form, the handle of the leash is mountable onto the harness or collar.

The conventional art presents a variety of problems, in particular the conventional leash and collar assembly is cumbersome and inconvenient to be carried by the animal. Accordingly, what is needed is a user-friendly and efficient leash and collar or harness assembly that is compact and does not need to be carried by the animal. In one form of the present invention, the collar/harness may be carried by the animal and will not encumber the normal movements of the animal and weighs less than approximately one pound.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document. act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an inclusive, accessible animal leash and collar or harness assembly is now met by a new, useful and nonobvious invention that is non-burdening to the animal and weighs less than approximately one pound.

The novel structure includes a retractable leash and collar or harness assembly. The leash and handle assembly includes a hub member preferably fully contained therein. The hub assembly preferably has a hollow interior, and a spring (e.g., power spring) with a leash coiled and enclosed within the hub assembly. The spring and leash remain in communication with each other. The handle preferably surrounds and includes the hub assembly sewn or otherwise enclosed therein. The leash extends from the forward end of the handle and is preferably interconnected to the collar assembly. In the preferred form of the collar assembly, at least one snap buckle, parachute buckle or similar connector allows the collar to be attached around the neck or body of the animal. Similarly, a harness assembly may be used to maintain control of the animal and is similarly connected to the leash.

More particularly, the novel retractable leash and handle assembly includes a hub assembly enclosed within the forward end of the handle. The hub assembly has a substantially hollow interior and an aperture formed in the hub. A coiled spring is enclosed within the hollow interior of the hub assembly. The coiled spring has a first end secured to the hub assembly and is biased to be retracted around the hub assembly. The coiled leash is enclosed within the hollow interior of the hub assembly in the retracted position. The coiled spring has a second end secured to a first, inner end of the coiled leash. A second, outer end of the coiled leash extends through the aperture formed in the hub assembly and is disposed externally of the hollow interior of the hub assembly and through the forward end of the handle.

In a further embodiment, the hub assembly may have a notched channel along its circumference, and the leash would be coiled around the hub assembly within the notched channel. The hub assembly may also include a push button or similar actuation or nesting mechanism to allow the user to stop the extension of the leash from the hub assembly at any desired length.

In yet another embodiment, the hub assembly may be included in both the leash and handle assembly as well as in the collar. The dual hub assemblies may include similar resistance to the release of the leash or may have different resistance to allow the leash to be released from one of hub assemblies prior to the release of the leash from the other hub assembly. One or both of the hub assemblies may also include a push button or similar actuation mechanism to allow the user to stop the extension of the leash from the respective hub assembly at any desired length. Furthermore, in one of the embodiments, the hub assembly in the handle may include more leash than the other of the hub assemblies on the collar.

The collar assembly or harness assembly include one or more connectors to allow the respective component to be securely connected around the neck or body of the animal. The collar or harness assembly also includes a further connector to connect the handle and hub assembly component to the collar or harness when the novel assembly is not in use. In a preferred form of this invention, the connection may be a magnetic connection such that the handle is easily attached or removed from the outer surface of the collar with only one hand. Another snap type connector may be provided on the exterior of the collar to allow the user to connect certain swag type items such as bows, sparkles or other distinctive items. In a preferred form of the present invention, the leash extends from the handle to a leash connector that is sewn into the collar assembly such that the leash is integrally connected to the collar assembly. In a preferred form of the harness assembly, the harness assembly includes the hub assembly therein and the leash is integrally connected to the handle and seamlessly attached to the collar or harness while in the stored or non-use position.

The retractable leash and collar assembly of this invention is preferably constructed of a flexible and lightweight material to allow the handle with the hub assembly therein to be folded and releasably attached to the flexible and foldable collar or harness to allow the overall assembly to be compactly and easily carried by the user in a pocket or purse. Alternately, the handle and hub assembly is sufficiently small and lightweight so that it may be releasably attached to the collar or harness by a connector such as a magnet, button, snap or hook and loop connector without interfering with the movement of the animal. Preferred materials include durable fabrics, woven canvas or Kevlar type materials. Additionally, the handle may include one or more magnets or similar attachment mechanisms thereon to allow the handle to be closed and folded upon itself and the further attached to the collar or harness.

In an alternate embodiment, the current invention comprises a retractable leash and harness assembly for a pet. The leash and harness assembly includes a hub with hollow interior, and a spring (e.g., power spring) and leash coiled and enclosed within the hub. The spring and leash remain in communication with each other in the interior of the harness and the leash extends to the handle. The harness is of a conventional configuration that fits around the body of the animal and is connected with one or more snap or parachute type connectors. The leash is preferably integrally connected to the harness and includes a connector that is integrally located in the forward end of the handle.

A hollow tubing or channel may be disposed within and longitudinally along the forward end of the handle. This channel allows the user to hold the handle while also controlling the release of the leash from the hub assembly through the forward end of the handle. The spring and leash may be positioned in the hub assembly such that the spring and leash are coiled around the housing assembly, and the spring is in communication with the interior of the housing assembly. In a further embodiment, the hub assembly may have a notched channel along its circumference, and the leash would be coiled around the hub assembly within the notched channel. In yet another embodiment, the hub assembly may include a push button or compressible configuration to allow the user to stop the release of the leash from the hub assembly at a desired length. In one form, depression of the button causes the leash to be pinched in the hub assembly such that movement of the leash from the hub assembly is stopped.

These and other important objects, advantages, and features of the invention will become clear as this disclosure proceeds. The invention accordingly comprises the features of construction. combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the nature and objects of the invention, reference should be made to the following detailed disclosure, taken in connection with the accompanying drawings, in which:

FIG. 1 is a top perspective view of the retractable leash assembly of the present invention.

FIG. 2 is another perspective view of the retractable leash assembly of the present invention.

FIG. 3 is an enlarged view of the handle of the retractable leash assembly according to an embodiment of the current invention.

FIG. 4 is a perspective view of the collar of the retractable leash assembly.

FIG. 5 is a further perspective view of the collar of the retractable leash assembly.

FIG. 6 is a perspective view of the retractable leash assembly showing the leash extended.

FIG. 7 is a perspective view of the folded collar of the retractable leash assembly.

FIG. 8 is a perspective view of the folded handle and collar of the retractable leash assembly.

FIG. 9 is a perspective view of the retractable leash assembly with a harness.

FIG. 10 is a perspective view of the hub assembly shown partially in the forward end of the handle of the present invention.

FIG. 11 is a perspective view of an alternate embodiment of the present invention.

FIG. 12 is a perspective view of an alternate embodiment of the present invention.

FIG. 13 is a top view of the alternate embodiment of FIG. 12.

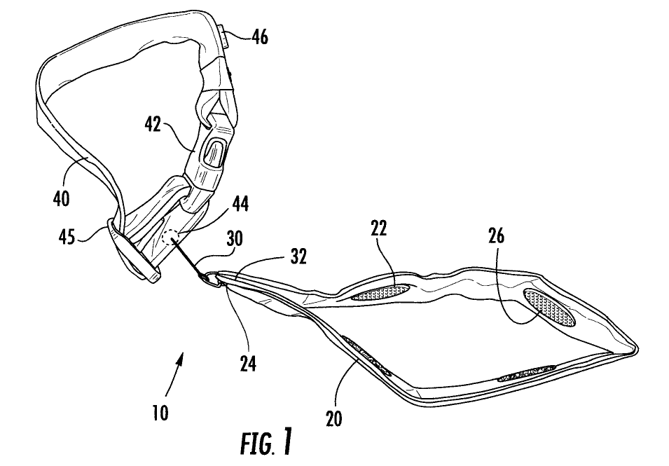

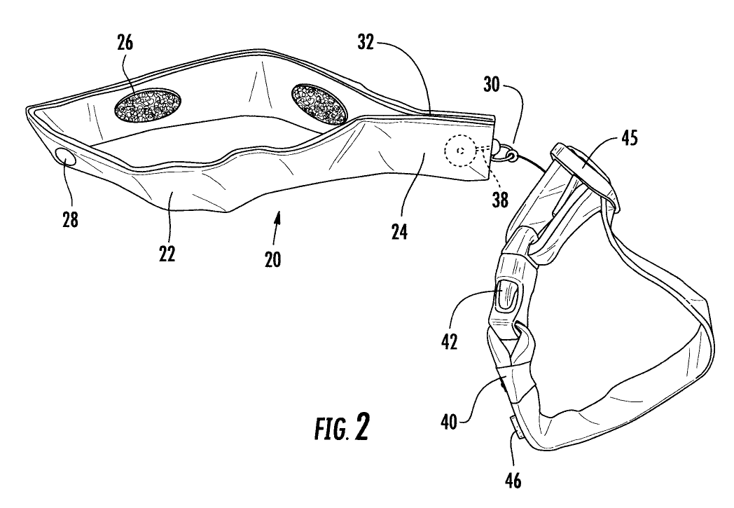

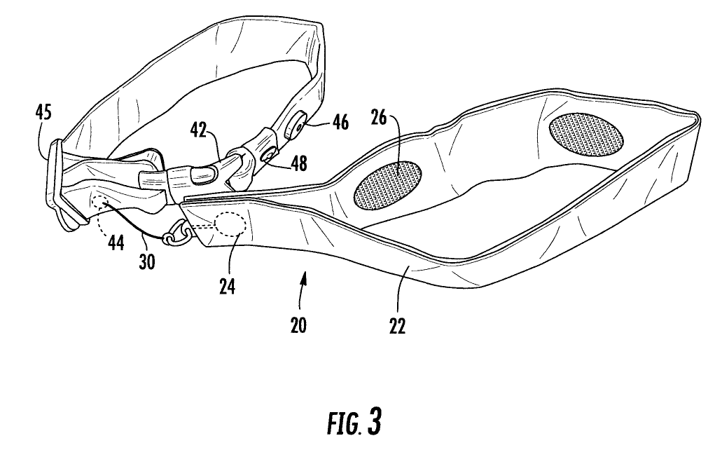

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

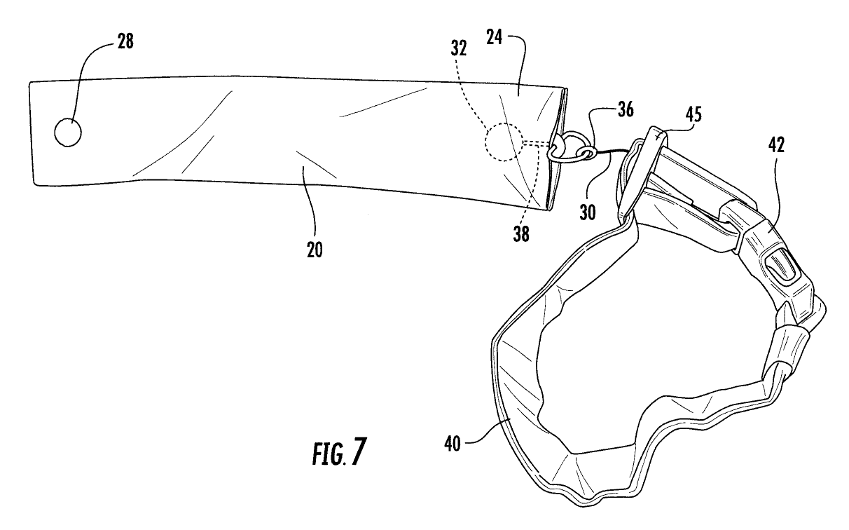

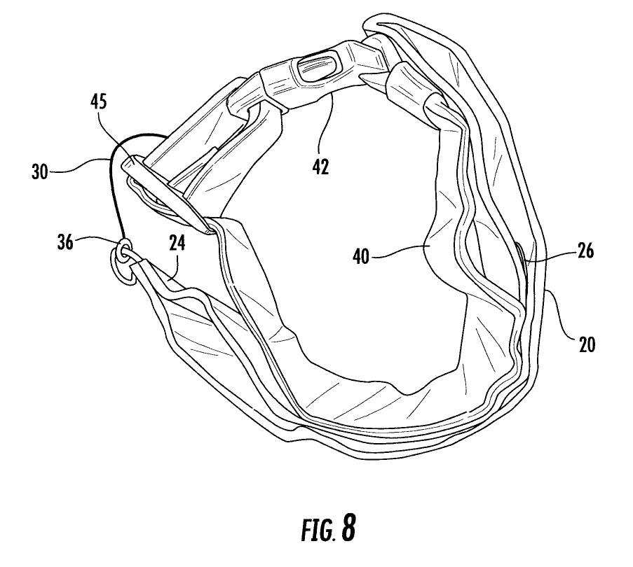

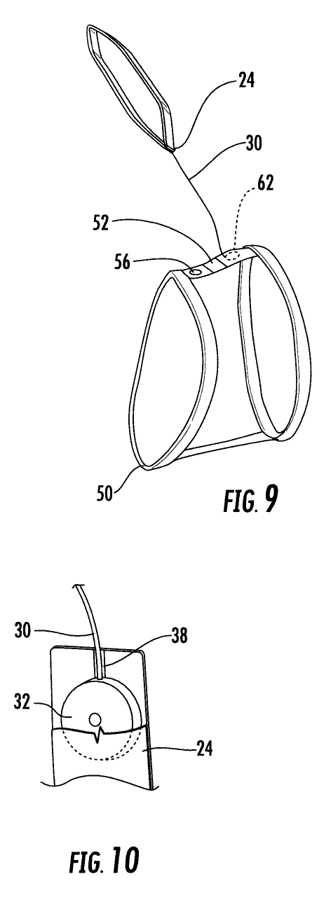

In an embodiment, the current invention includes a retractable leash and collar assembly 10 consisting generally of a handle 20, leash 30 and collar 40. The handle 20 includes the hub assembly 32 contained in the forward end 24 thereof. The hub assembly is generally denoted as a whole component in the Figures by the reference numeral 32. The handle 20 is preferably configured with a loop portion 22 and a forward end 24. The loop portion may include a hook and loop material or similar type of connecting configuration to form an interior connector 26 to allow the user to fold the loop portion 22 of the handle 20 on itself as shown In FIG. 7. The exterior of the handle also preferably includes an exterior connector 28 such as a magnet, button, snap or hook and loop material to allow the handle 20 to be releasably attached to a complementary connector on the exterior of the collar as shown in FIG. 8. In a preferred form of the present invention, the handle extends around at least three fourths of the exterior of the collar to provide a compact leash and collar assembly 10. Additionally, because of the flexibility of the materials used for construction, the entire retractable leash and collar assembly 10 may be folded over itself again to provide a compact assembly which is readily transportable in the pocket or purse of the user.

The forward end 24 of the handle 20 fully encloses and retains the hub assembly 32 therein. A passageway 38 extends from the hub assembly 32 to the front of the forward end 24 of the handle 20 to allow the leash 30 to movably pass there through. The leash 30 extends from the lead connector 36 adjacent to the handle 20 to the lead end 34 which is adjacent to the collar 40. In a preferred form of the present invention, the handle is formed of a flexible material that is lightweight and foldable. It is anticipated that the handle may be made of a fabric material and may potentially also include a reinforcing material therein to increase the durability of the handle while not limiting the flexibility and foldability of the handle 20.

The hub assembly 32 can be formed of any suitable material, for example metal, plastic, carbon fiber, etc. Examples of commercially availability components that are suitable for use as a hub assembly include Carabiner retractable reels manufactured by Universal Mercantile Exchange, Inc. of Walnut, Calif. or retractable lifelines manufactured by Global Equipment Co., Inc. of Buford, Ga. The hub assembly 32 includes capsule section, which encloses a reel/spring housing assembly. The hub assembly 32 not only houses the capsule but also encloses the spring member and the leash when the leash is retracted. The spring is a conventional spring that is wound or coiled around the capsule to bias the leash to a retracted position. The spring may have an inner end connection attached to the interior of the capsule. The opposite end of the spring terminates in the leash 30, which in turn leads to and is interconnected to the lead end 34 that is preferably integrally attached to the collar 40 at the leash connector 44. The leash 30 may alternately be wound around an outer groove on the capsule in outer relation to a spring.

One of ordinary skill in the art would be capable of optimizing size/diameter of the size/diameter of hub assembly 32, width of hub assembly, turns of the spring required, torque required within hub assembly 32, among other optimizing factors when considering the life cycle required of the apparatus, environment in which the spring is used (e.g., frequent winding and unwinding due to leash 30, retracting in and out of the capsule), etc. The exterior of the hub assembly 32 may also have a sloped plane to facilitate the spooling of leash 30. The hub assembly may also be formed of a pair of nesting components such that when the components are squeezed together by the user, the leash 30 may be pinched there between to prevent an additional length of the leash from being drawn from the hub assembly 32. This form of the hub assembly includes at least one compressible pressure element disposed thereon to restrict the movement of the leash from the hub assembly when the pressure element is depressed.

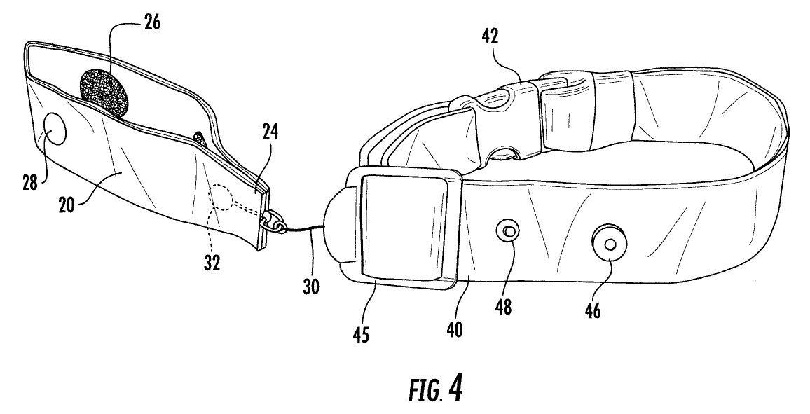

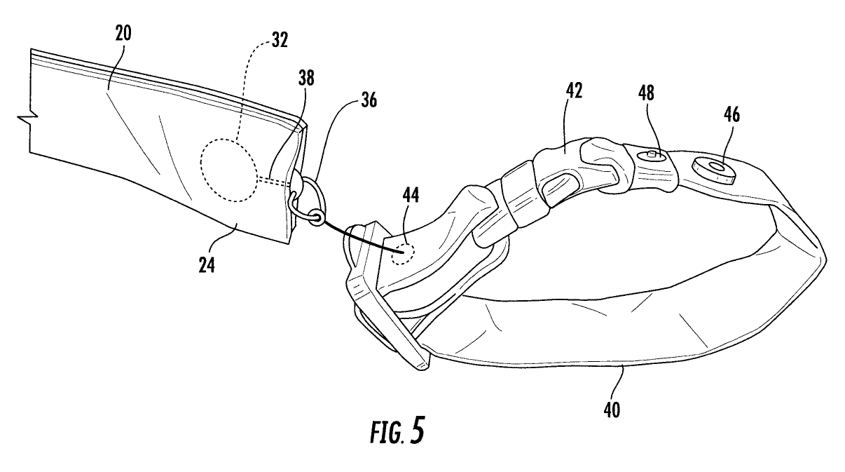

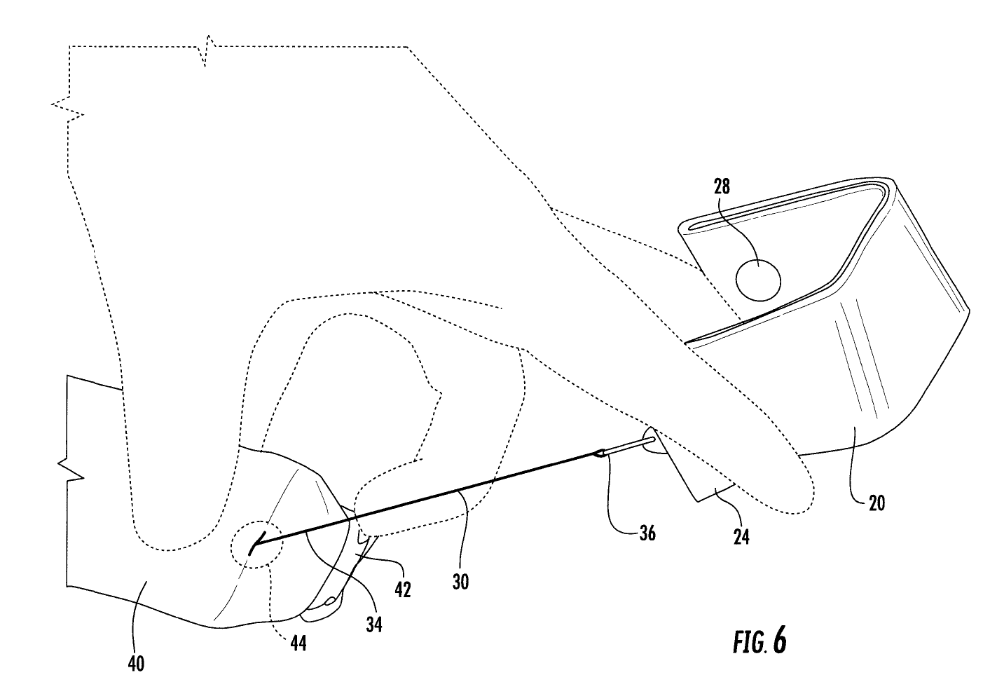

The collar is generally illustrated in FIGS. 4 and 5 and is designated generally by the reference number 40. The collar 40 includes a clasp 42, leash connection 44, an adjustable connector 45, a handle connector 46 and a swag connector 48. The swag connector 48 is located on the outer surface of the collar to provide a further connector thereon to allow decorative items to be attached thereto. The collar 40 is preferably made of a flexible material that may include additional reinforcing materials to increase the durability while not adversely affecting the flexibility. In one form of the invention, the clasp 42 and leash connection 44 are located general adjacent to each other, although they may be further spaced apart without affecting the functionality of the present invention. The leash connection 44 is preferably integrally connected or sewn into the collar 40 so that the user need not clip or otherwise attach the leash to the collar. The handle connector 46 is preferably a magnet or similar member that is located on the exterior surface of the collar 40 to provide a convenient location to attach the exterior connector 28 of the handle 20 thereto. The collar 40 may also contain an additional swag connector 48 that consists of a snap type connector to allow bows, sparkles or other distinctive materials to the collar. The collar 40 may also include an adjustable connector 45 to allow the collar to be adjusted to a pet's size via an adjustable slide mechanism. In general function (e.g., installation onto the pet and adjustability), the collar 40 can be utilized similar to conventional pet collars, and as such includes the appropriate straps and configuration for adjustability. Additionally, the leash connection 44 of the collar 40 and the lead connector 34 of the handle 20 are preferably integrally connected to provide an overall leash and collar assembly that is a unitary integral component that is easily folded for compact carrying by the user as shown in FIG. 8.

The retractable leash and collar assembly is generally denoted in the Figures as reference numeral 10. The collar 40 is attached to the animal by wrapping the collar around the animal and using the clasp 42 to retain the collar around the animal. The leash 30 is then removed from the collar 40 by grasping the handle and removing the handle connector 46 from the exterior connector 28. The user can then allow the leash to be withdrawn from the hub assembly 32 by holding the handle and allowing the animal to walk away from the user. An advantage of the present invention is that as the leash is withdrawn from the hub assembly 32, the pet does not feel the vibration of the leash being withdrawn from the hub assembly on their back or around their neck. In the alternate form of the present invention, if the user wants to stop the extension of the leash, they may compress the hub assembly to stop the leash.

The harness form of the present invention is generally illustrated in FIG. 9. The harness is designated generally by the reference number 50. The harness 50 includes a pair of clasps 52 and a handle connector 56. The harness 50 is preferably made of a flexible material that may include additional reinforcing materials to increase the durability while not adversely affecting the flexibility. In one form of the invention, the clasps 52 are located generally spaced apart from a hub assembly 62 that is preferably integrally sewn into the harness 50, although the clasps 52 and hub assembly 62 may be located generally adjacent to each other without affecting the functionality of the present invention. The handle connector 56 is complementary to an exterior connector 28 on the handle 20 and is located on the exterior surface of the harness 50 at a convenient location to attach the exterior connector 28 of the handle 20 thereto. When attached to the pet, the clasps 52, handle connector 56 and hub assembly are 62 are preferably located along the back of the animal. The harness 50 may also include an adjustable feature to allow the harness to be adjusted to a pet's size via an adjustable slide mechanism. In general function (e.g., installation onto the pet, adjustability), harness 50 can be utilized similar to conventional pet harnesses, and as such includes the appropriate straps and configuration for adjustability. Although the preferred form of the harness shown as including the hub assembly 62 integrally connected to the forward end 24 of the handle 20, an alternate form of the harness 50 may be interchangeable for customization and include an additional connector for personalization.

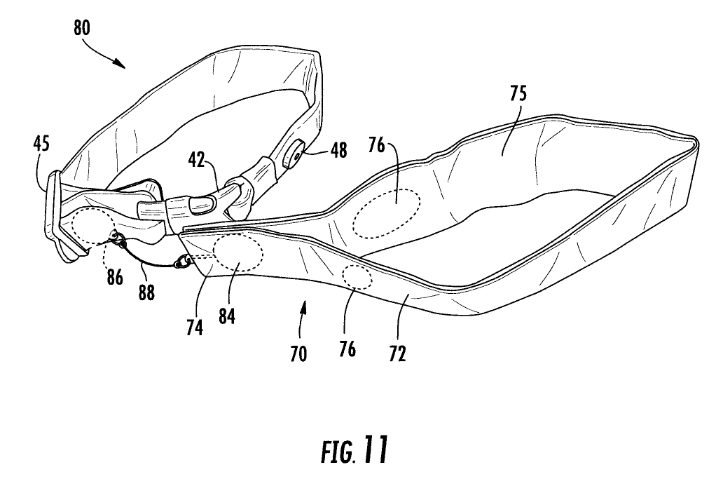

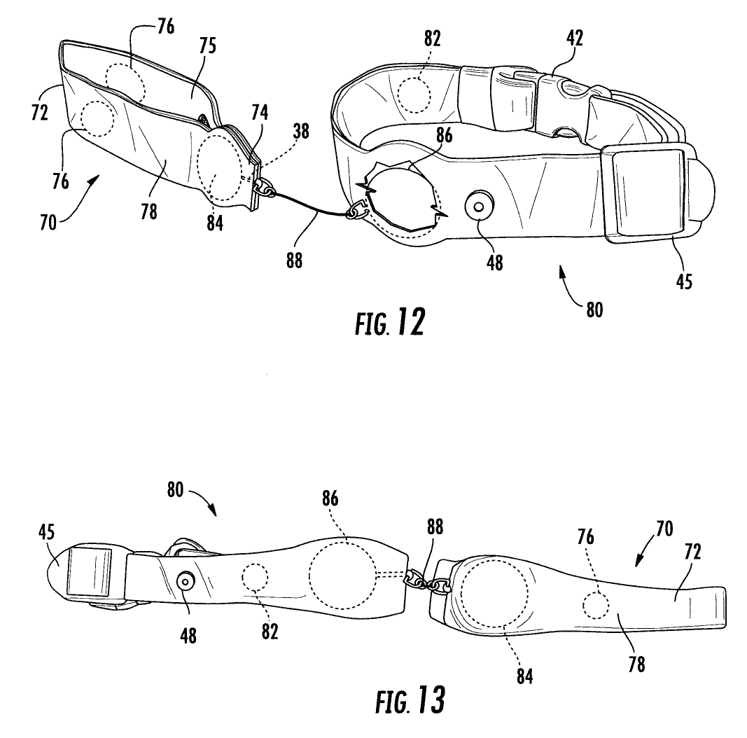

FIGS. 11-13 are illustrative of further embodiments of the present invention. As shown, this embodiment includes an elongate handle 70 having a loop portion 72 with a forward end 74. In this embodiment, the handle includes a length dimension defined by the loop portion 72 and a width dimension. The width dimension of the embodiment shown in FIGS. 12-13 is increased near the forward end 74 of the elongate handle 70. The handle 70 preferably includes multiple connectors such as handle magnets 76 thereon. As shown, the magnets 76 may be located in the loop portion 72 of the handle 70 to allow the loop portion 72 to be closeable by contacting the magnets 76 together to temporarily retain the opposed interior surfaces 75 of the loop portion 72 together as desired by the user. The magnets 76 on the loop portion 72 are also preferably oriented to enable the user to secure the handle 70 to a connector such as a collar magnet 82 located on the exterior surface 78 of the collar 80. Although the present embodiments are illustrated with a collar magnet 82, this feature of the present embodiments may also be accomplished without a separate collar magnet 82. When the collar magnet is not present, the magnets 76 of the handle 70 will engage a variety of metal elements located on the collar 80, such as a clasp or connector.

This alternate embodiment preferably includes a first hub assembly 84 located in the forward end 74 of the handle 70 adjacent to the enlarged width dimension. The forward end also preferably includes a forward passageway 38 extending from the hub assembly 84 to the end of the handle 70. Additionally, a second hub assembly 86 may be located in the collar 80 adjacent to an increased area of width dimension. Each of the first and second hub assemblies, 84 and 86, are interconnected by a leash 88. The leash 88 may include one or more releasable connectors or may be fixed between the first and second hub assemblies, 84 and 86. As shown in the drawings, it is preferable that the leash 88 extends from the sides of the first and second hub assemblies, 84 and 86. As described above, an important feature of the present invention is to optimize the size and diameter of first and second hub assemblies 84 and 86 as well as the width of each hub assembly. The size and diameter affect the number of turns of the spring required and torque required within each hub assembly. Other factors are also to be considered when selecting the desired hub assembly include the environment in which the spring is used (e.g., frequent winding and unwinding due to the leash 88, retracting in and out of the capsule), etc. The exterior of each hub assembly may also have a sloped plane to facilitate the spooling of the leash 88. The hub assembly may also be formed of a pair of nesting components or with a button such that when the components are squeezed together or the button is depressed by the user, the leash 88 may be pinched therebetween to prevent an additional length of the leash from being drawn from each hub assembly. This form of the present invention includes hub assemblies having at least one compressible pressure element disposed thereon to restrict the movement of the leash 88 from the hub assembly when the pressure element is depressed.

In the preferred form of these embodiments, the combination of the first hub assembly 84 and second hub assembly 86 allow the user to have an additional length of leash 88 than is readily available with the embodiments having a single hub assembly 32 as described above. Additionally, the first hub assembly 84 may preferably include a button, nesting or similar restrictive leash release feature to allow the user to selectively restrict the removal of the leash 88 from the first hub assembly 84. In this embodiment, the second hub assembly 86 preferably does not include the ability to restrict the removal of the leash from the second hub assembly 86 except through the spring biased resistance provided by the spring resistance in the second hub assembly 86. Alternately, a button (not shown) may be used on the second hub assembly 86 of the collar 80 to restrict the removal of the leash from the second hub assembly 86. In this embodiment. the resistance to the release of the leash 88 from each of the hub assemblies. 84 and 86 may be different such that the leash is released from one of the hub assemblies prior to the release of the leash 88 from the other of the hub assemblies. In a preferred form, as the user separates the handle 70 from the collar 80 the resistance to the release of the leash 88 from the second hub assembly 86. is less than the resistance to the release of the leash 88 from the first hub assembly 84 to allow the leash 88 to be released from the second hub assembly 86 first before the leash 88 is released from the first hub assembly 84. In this form of the invention, a predetermined length of leash 88 will initially release from the second hub assembly 86 and then the user will be able to determine the amount of additional length of the leash 88 that is to be used by compressing or depressing the button or nested first hub assembly 84.

As shown in FIGS. 12 and 13, the width of the handle 70 and collar 80 may be increased adjacent to the location of the first hub assembly 84 and second hub assembly 86. The increase in width in this area allows larger hub assemblies to be utilized with this embodiment to provide an increased length of the leash 88 in the hub assemblies. Furthermore, the additional width and larger hub assemblies allows this embodiment to readily incorporate the feature of the button or nesting features described herein.

The embodiments shown in FIG. 11-13 provide a versatile and compact retractable leash and collar assembly. Once the collar 80 (or harness) is placed around the neck of the pet, the user may release the handle 70 from the collar 80 by separating the handle magnets 76 from the optional collar magnet 82. The user may then open the loop portion 72 by separating the handle magnets 76 to separate the interior surfaces 75 of the loop portion 72. When the user is ready to walk the pet, the user may allow the portion of the leash 88 located in the second hub assembly 86 to be drawn from the collar 80. Next, the user may selectively allow an additional length of leash 88 to be withdrawn from the first hub assembly 84. If the buttons or nesting feature are not present in the first hub assembly 84, the user may manually control the length of least that is releasable from the first hub assembly. When the user is finished with the collar and leash of the present invention, the handle magnets 76 on the loop portion 72 may be allowed to engage each other to position the interior surfaces 75 of the handle portion adjacent to each other. The user may then place one or more of the handle magnets 76 adjacent to the collar magnet 82 to secure the handle 70 adjacent to the collar. If this procedure is done after removal of the collar 80 from the pet, the collar and retractable leash assembly may then be folded again and conveniently stored in the pocket or purse of the user.

1. A retractable pet leash for use on an animal having a neck comprising:
a collar assembly;
a flexible loop shaped handle member having a forward end and the handle member further has an inner surface and an outer surface and a connector located on the inner surface of the loop shape to allow the handle to be securely closed for folding;
a first hub assembly disposed in the forward end of the handle member wherein the hub assembly includes a biased member connected to a first end of a leash;
an opening in the forward end of the handle member to allow the leash line to extend therethrough in response to the extension and retraction of the leash line from the first hub assembly;
a second hub assembly located on the collar assembly wherein the second hub assembly includes a biased member connected to a second end of a leash; and
the leash is an elongated leash element having first and second ends and leash connector configured to couple the leash to the first hub assembly and the second hub assembly.

2. The retractable pet leash of claim 1 wherein the first hub assembly includes a spool member and a housing and being disposed within the first end of the handle member and the spool member being arranged to rotate about an axis to release or retract the leash element wrapped about the spool member, wherein the spool member is rotatably biased to retract the leash element within the housing and wherein the first hub assembly further includes at least one compressible pressure element disposed thereon to restrict the movement of the leash line from the hub assembly when the at least one pressure element is depressed.

3. The retractable pet leash of claim 2 wherein the second hub assembly includes a spool member and a housing and being disposed within the collar assembly and the spool member being arranged to rotate about an axis to release or retract the leash element wrapped about the spool member, wherein the spool member is rotatably biased to retract the leash element within the housing.

4. The retractable pet leash of claim 1 wherein the collar assembly is further sized and configured to be placed around the neck of the animal wherein the collar assembly includes a clasp to allow the collar assembly to be retained around the neck of the animal and a leash connection adapted to connect the second end of the leash to the second hub assembly on the collar assembly and wherein the handle member has an inner surface and an outer surface and the outer surface of the handle member includes a connector thereon to allow for the coupling of the handle member to a complementary connector on the collar assembly.

5. The retractable pet leash of claim 4 wherein the connector on the outer surface of the handle member is a magnet.

6. The retractable pet leash of claim 5 wherein the handle member includes a loop shaped portion having a plurality of magnets thereon to allow the loop shaped member to be closed by positioning the magnets generally adjacent to each other.

7. The retractable pet leash according to claim 6, wherein the collar assembly has an inner surface and an outer surface and the handle member is foldable along the outer surface of the collar assembly and each of the handle member and collar assembly include magnets thereon and are further foldable to provide a compact retractable leash assembly.

8. A retractable pet leash for use on an animal having a neck, comprising:
a flexible loop shaped handle member having a lengthwise dimension and a width dimension wherein the width dimension is smaller than the length dimension and the lengthwise dimension includes a forward end aligned therewith and an inner surface and an outer surface;
a collar sized and configured to be placed around the neck of the animal wherein the collar includes an outer surface having a clasp thereon to allow the collar to be retained around the neck of the animal;
a leash including an elongated leash element having first and second ends wherein the first end is attached to one of the collar or the handle member and a second end thereof is configured to be coupled to the other of the collar or handle member;
a first hub assembly disposed in the handle member and a second hub assembly disposed in the collar wherein the first hub assembly and the second hub assembly include a biased member operatively connected to the first and second end of the leash;
an opening adjacent to the first hub assembly to allow the leash to extend therethrough in response to the extension and retraction of the leash element from the first hub assembly; and
wherein the outer surface of the handle member has connector on an outer surface thereof to allow for the attachment of the handle member to a complementary connector on the outer surface of the collar.

9. The retractable pet leash of claim 8 wherein the first hub assembly and second hub assembly provide resistance to the release of the leash from each of the hub assemblies.

10. The retractable pet leash of claim 9 wherein the amount of resistance applied to the leash by the first hub assembly is greater than the amount of resistance to the leash applied by the second hub assembly.

11. The retractable pet leash of claim 9 wherein the amount of resistance applied to the release of the leash from the first and second hub assemblies is approximately equal.

12. The retractable pet leash of claim 8 wherein the first hub assembly includes a spool member and a housing and being disposed within the first end of the handle member and the spool member being arranged to rotate about an axis to release or retract the leash element wrapped about the spool member and the spool member is rotatably biased to retract the leash element within the housing and wherein the first hub assembly further includes at least one compressible pressure element disposed thereon to restrict the movement of the leash line from the hub assembly when the at least one pressure element is depressed.

13. The retractable pet leash of claim 12 wherein the second hub assembly includes a spool member and a housing and being disposed within the collar and the spool member being arranged to rotate about an axis to release or retract the leash element wrapped about the spool member and the spool member is rotatably biased to retract the leash element within the housing.

14. The retractable pet leash according to claim 8, wherein the first hub assembly includes at least one compressible pressure element disposed thereon to restrict the movement of the leash line from the first hub assembly when the at least one pressure element is depressed and the at least one pressure element is movable between open and closed positions wherein the at least one pressure element is biased in the open position wherein the leash is removable from the first hub assembly.

15. The retractable pet leash according to claim 8 wherein the connector on the handle member includes a plurality of magnets thereon and the connector on the outer surface of the collar includes a magnet thereon wherein the handle member is securable adjacent to the collar wherein at least one magnet from the handle member is positionable adjacent to the magnet on the outer surface of the collar.

16. A retractable pet leash for use on an animal having a neck, comprising:
a flexible loop shaped handle member having a lengthwise dimension and a width dimension wherein the width dimension is smaller than the length dimension and the lengthwise dimension includes a forward end aligned therewith and an inner surface and an outer surface;
a collar sized and configured to be placed around the neck of the animal wherein the collar includes an outer surface having a clasp thereon to allow the collar to be retained around the neck of the animal;
a leash including an elongated leash element having first and second ends wherein the first end is attached to one of the collar or the handle member and a second end thereof is configured to be coupled to the other of the collar or handle member;
a first hub assembly disposed in the handle member and a second hub assembly disposed in the collar wherein the first hub assembly and the second hub assembly include a biased member operatively connected to the first and second end of the leash;
an opening adjacent to the first hub assembly to allow the leash to extend therethrough in response to the extension and retraction of the leash line from the first hub assembly;
wherein the first hub assembly includes a spool member and a housing and being disposed within the first end of the handle member and the spool member being arranged to rotate about an axis to release or retract the leash element wrapped about the spool member and the spool member is rotatably biased to retract the leash element within the housing and wherein the first hub assembly further includes at least one compressible pressure element disposed thereon to restrict the movement of the leash from the hub assembly when the at least one pressure element is depressed; and
wherein the second hub assembly includes a spool member and a housing and being disposed within the collar and the spool member being arranged to rotate about an axis to release or retract the leash element wrapped about the spool member and the spool member is rotatably biased to retract the leash element within the housing.

17. The retractable pet leash of claim 16 wherein the first hub assembly and second hub assembly provide resistance to the release of the leash from each of the hub assemblies and wherein the amount of resistance applied to the leash by the first hub assembly is greater than the amount of resistance to the leash applied by the second hub assembly.

18. The retractable pet leash of claim 16 wherein the first hub assembly and second hub assembly provide resistance to the release of the leash from each of the hub assemblies and wherein the amount of resistance applied to the leash by the first hub assembly is approximately equal to the amount of resistance to the leash applied by the second hub assembly.

19. The retractable pet leash of claim 16 wherein the handle member includes a loop shaped portion having a plurality of magnets thereon to allow the loop shaped member to be closed by positioning the magnets generally adjacent to each other.

20. The retractable pet leash according to claim 16 wherein the handle member includes a plurality of magnets thereon and the outer surface of the collar includes a magnet thereon wherein the handle member is securable adjacent to the collar wherein at least one magnet from the handle member is positionable adjacent to the magnet on the outer surface of the collar.
